(19) United States
(12) Patent Application Publication
(10) Pub. No.: US 2018/0222032 A1
(43) Pub. Date: Aug. 9, 2018

(54) Shock Absorbing Protection Structure for Handheld Power Tool

(71) Applicants: Chia-Ya Cheng, Taoyuan City (TW); Chih-Kuan Hsieh, Hemei Township (TW)

(72) Inventors: Chia-Ya Cheng, Taoyuan City (TW); Chih-Kuan Hsieh, Hemei Township (TW)

(21) Appl. No.: 15/424,925

(22) Filed: Feb. 6, 2017

(51) Int. Cl. B25F 5/00; B25D 17/24; B08B 7/02

(52) U.S. Cl. CPC B25F 5/006; B25D 2217/0073; B08B 7/022; B25D 17/24

(57) ABSTRACT

A shock absorbing protection structure for a handheld tool contains: a power tool, a shock absorption sleeve, and at least one stopper. The power tool includes a drive block which has a switch configured to turn on/off the drive block, the driving block also has a coupling tube which has a tool head fixed on the coupling tube away from the drive block, and the power tool includes a joining portion formed on the power tool. The shock absorption sleeve is fitted on the joining portion of the power tool, and between the shock absorption sleeve and the joining portion is defined an accommodation space. The at least one stopper is flexible and is defined between the shock absorption sleeve and the joining portion of the power tool, and the at least one stopper is located at the accommodation space so as to absorb vibration.

### BACKGROUND OF THE INVENTION

### Field of the Invention

The present invention relates to a handheld power tool, and more particularly to a shock absorbing protection structure for a handheld power tool.

### Description of the Prior Art

A conventional handheld power tool is operated reciprocately or rotatably. When the conventional handheld power tool is operated reciprocately by way of high pressure gas or electricity (i.e., the conventional handheld power tool is operated pneumatically or electrically), an impact part strikes a tool head reciprocately so as to cut, punch, eliminate rusts, and engrave workpieces.

Referring to FIGS. 7 and 8, a conventional handheld power tool 90 contains: a body 91, a transmission part 92, a connection unit 93, and a tool head 94. The body 91 has a drive block 911, a switch 912 disposed on the drive block 911, and a coupling tube 913 connecting with the drive block 911, wherein the coupling tube 913 has an orifice 9131 defined on a central position of one end thereof away from a drive block 911, a groove 9132 formed on an outer wall of the coupling tube 913, and two notches 9133 communicating with the orifice 9131. The coupling tube 913 further has a chamber 9134 communicating with the orifice 9131, and the camber 9134 has an air valve 914 adjacent to the drive block 911 and has an impact part 915 moving between the air valve 914 and the orifice 9131. The transmission part 92 has a column 921 and a push disc 922, and the connection unit 93 has two limitation protrusions 931 and a defining ring 932, wherein the column 921 of the transmission part 92 inserts into the orifice 9131 of the coupling tube 913 of the body 91, and the two limitation protrusions 931 of the connection unit 93 are housed in the two notches 9133 of the coupling tube 913 so that the defining ring 932 of the connection unit 93 retain in the groove 9132 of the coupling tube 913 so that the transmission part 92 limits in the one end of the coupling tube 913 of the body 91 away from the drive block 911. The drive head 94 has a fitting sheath 941 fitted on an outer wall of the coupling tube 913, wherein the fitting sheath 941 accommodates a resilient element 942 and a holding seat 943. The holding seat 943 has a plurality of rust removal needles 944 extending out of the fitting sheath 941, and the holding seat 943 abuts against the push disc 922 of the transmission part 92.

The power tool 90 includes a grip portion 90a and a support portion 90b, wherein the grip portion 90a is located between the drive block 911 and the coupling tube 913 of the body 91, and the support portion 90b is fixed on the fitting sheath 941 and corresponding to the tool head 94.

In operation, a user holds the grip portion 90a with one hand and grips the support portion 90b with the other hand. After turning on the switch 912, high pressure gas pushes the impact part 915 to move toward the transmission part 92 from the drive block 911 via air valve 914 so that the transmission part 92 is hit by the impact part 915. Thereafter, the high pressure gas is controlled by the air valve 914 to push the impact part 915 to strike the air valve 914, hence the impact part 915 is pushed reciprocately so as to strike the transmission part 92, and the push disc 922 of the transmission part 92 pushes the holding seat 943 of the tool head 94 so that the plurality of rust removal needles 944 are driven by the holding seat 943 to remove rusts.

However, the when the impact part 915 strikes the transmission part 92, reaction force passes to the other hand of the user which grips the support portion 90b, thus causing gripping discomfort, fatigue, and injury to the user's hands.

The present invention has arisen to mitigate and/or obviate the afore-described disadvantages.

### SUMMARY OF THE INVENTION

The primary objective of the present invention is to provide a shock absorbing protection structure for a handheld power tool which contains a shock absorption sleeve fitted on an outer wall of a joining portion of a power tool, and between the shock absorption sleeve and the joining portion is defined at least one stopper, such that the shock absorption sleeve and the at least one stopper absorb vibration as the handheld power tool operates, thus reducing reaction force to user's hands.

To obtain above-mentioned objective, a shock absorbing protection structure for a handheld power tool provided by the present invention contains: a power tool, a shock absorption sleeve, and at least one stopper.

The power tool includes a drive block for providing vibration power, and the driving block has a switch disposed on the drive block so as to turn on/off the drive block, the driving block also has a coupling tube connecting with the drive block, the coupling tube has a tool head fixed on one end of the coupling tube away from the drive block, and the power tool includes a joining portion formed on an outer wall of the power tool;

The shock absorption sleeve is fitted on an outer wall of the joining portion of the power tool, and between the shock absorption sleeve and the joining portion is defined an accommodation space.

The at least one stopper is flexible and is defined between the shock absorption sleeve and the joining portion of the power tool, and the at least one stopper is located at the accommodation space so as to absorb vibration.

### BRIEF DESCRIPTION OF THE DRAWINGS

FIG. 1 is a perspective view showing the exploded components of a shock absorbing protection structure for a handheld power tool according to a preferred embodiment of the present invention.

FIG. 2 is another perspective view showing the exploded components of the shock absorbing protection structure for the handheld power tool according to the preferred embodiment of the present invention.

FIG. 3 is a perspective view showing the assembly of the shock absorbing protection structure for the handheld power tool according to the preferred embodiment of the present invention.

FIG. 4 is a cross sectional view showing the assembly of the shock absorbing protection structure for the handheld power tool according to the preferred embodiment of the present invention.

FIG. 5 is another cross sectional view showing the operation of the shock absorbing protection structure for the handheld power tool according to the preferred embodiment of the present invention.

FIG. 6 is a cross sectional view showing the assembly of the shock absorbing protection structure for the handheld power tool according to another preferred embodiment of the present invention.

FIG. 7 is a perspective view showing the assembly of a conventional handheld power tool.

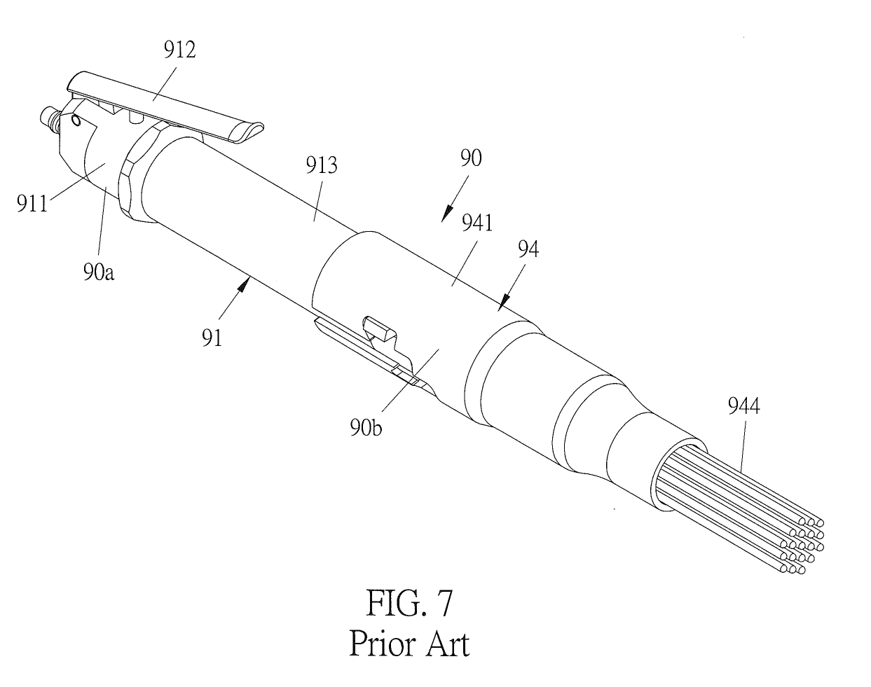

FIG. 8 is a cross sectional view showing the assembly of the conventional handheld power tool.

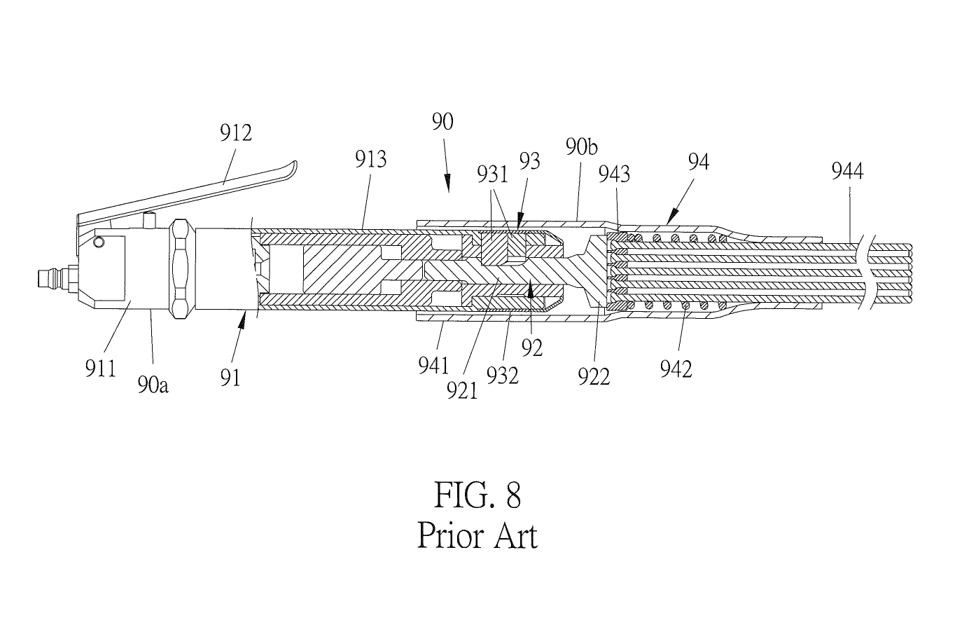

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

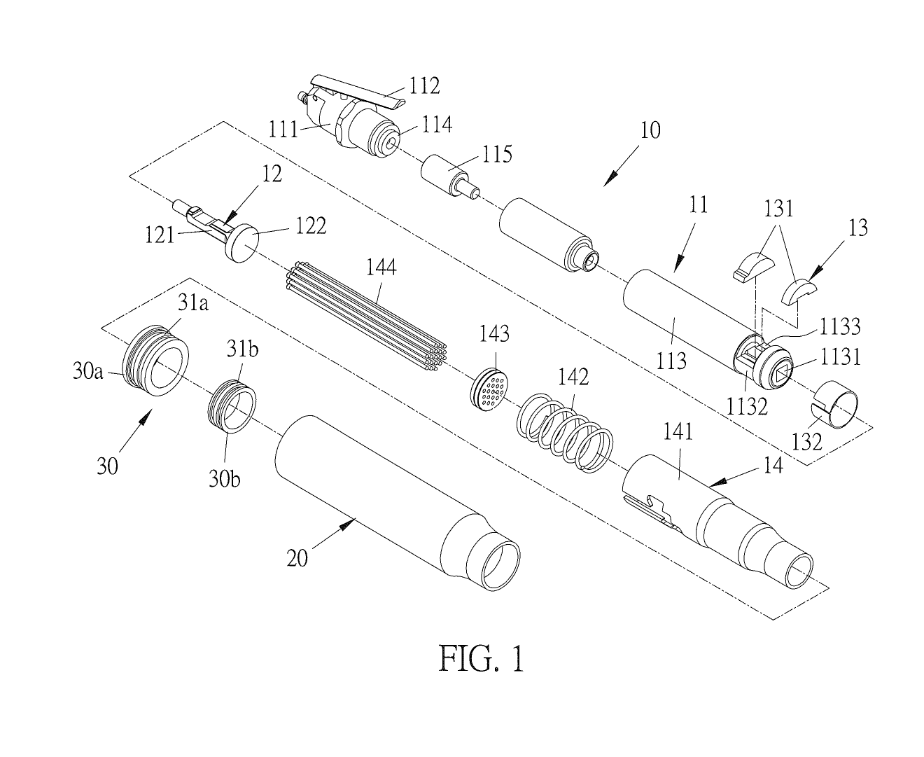

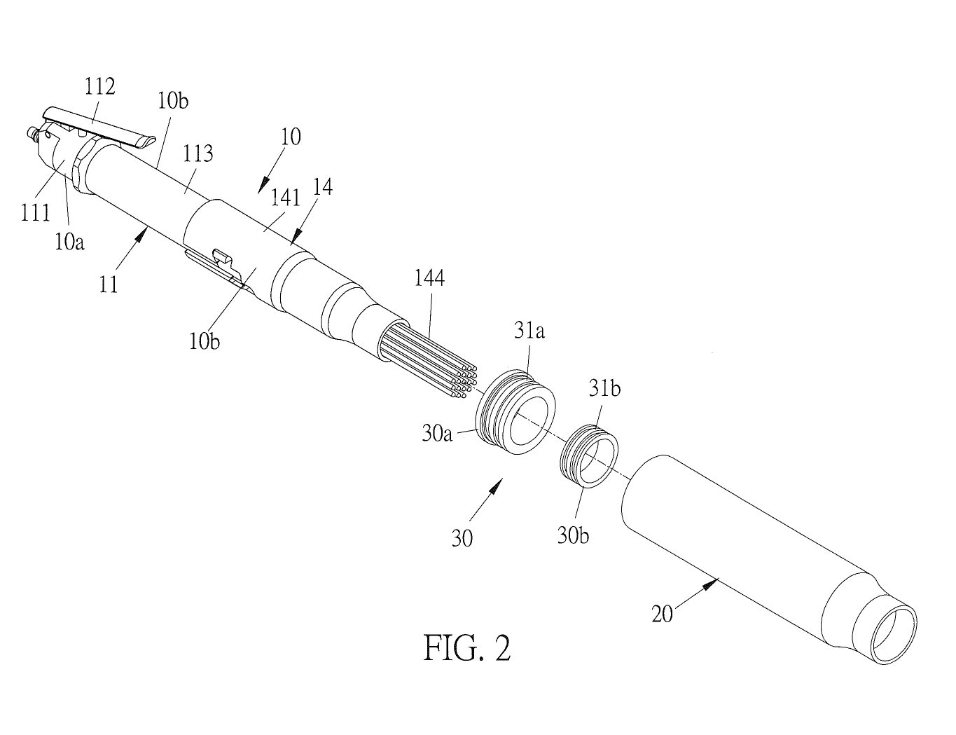

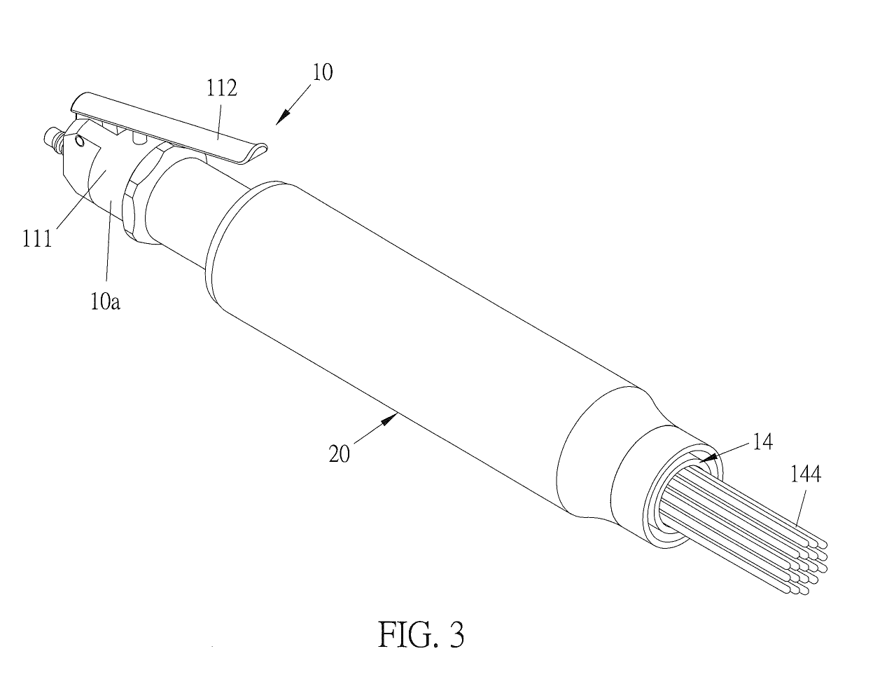

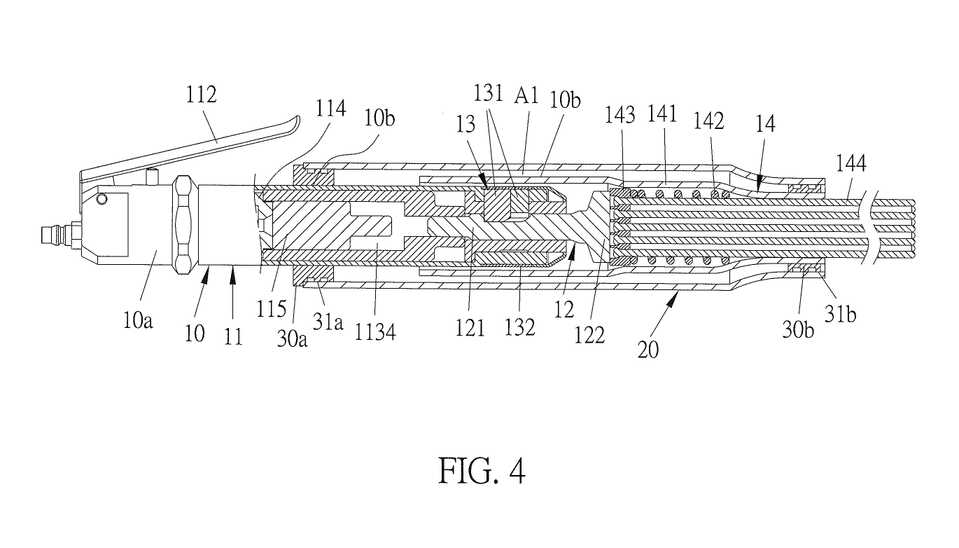

With reference to FIGS. 1 to 4, a shock absorbing protection structure for a handheld tool according to a preferred embodiment of the present invention comprises: a power tool 10, a shock absorption sleeve 20, and at least one stopper 30.

The power tool 10 includes a body 11, a transmission part 12, a connection unit 13, and a tool head 14, wherein the body 11 has a drive block 111, a switch 112 disposed on the drive block 111, and a coupling tube 113 connecting with the drive block 111. The coupling tube 113 has an orifice 1131 defined on a central position of one end thereof away from the drive block 111, and the coupling tube 113 also has a groove 1132 formed on an outer wall thereof, wherein the groove 1132 has two notches 1133 communicating with the orifice 1131, the coupling tube 113 further has a chamber 1134 communicating with the orifice 1131, wherein the chamber 1134 houses an air valve 114 adjacent to the drive block 111, and the chamber 1134 also accommodates an impact part 115 moving between the air valve 114 and the orifice 1131. The transmission part 12 has a column 121 and a push disc 122, the connection unit 13 has two limitation protrusions 131 and a defining ring 132, wherein the column 121 of the transmission part 12 inserts into the orifice 1131 of the coupling tube 113 of the body 11, the two limitation protrusions 131 of the connection unit 13 are housed in the two notches 1133 of the coupling tube 113, the defining ring 132 of the connection unit 13 retains in the groove 1132 of the coupling tube 113 so that the transmission part 12 is fixed in the one end of the coupling tube 113 away from the drive block 111. The tool head 14 includes a fitting sheath 141 fitted on the outer wall of the coupling tube 113, the fitting sheath 141 houses a resilient element 142 and a holding seat 143, the holding seat 143 accommodates a plurality of rust removal needles 144 extending out of the fitting sheath 141, and the holding seat 143 abuts against the push disc 122 of the transmission part 12.

The power tool 10 includes a grip portion 10a and a joining portion 10b, wherein the grip portion 10a is located between the drive block 111 and the coupling tube 113 of the body 11. In this embodiment, the joining portion 10b is the coupling tube 113 and the fitting sheath 141.

The shock absorption sleeve 20 is fitted on an outer wall of the joining portion 10b of the power tool 10, and between the shock absorption sleeve 20 and the joining portion 10b is defined an accommodation space A1.

The at least one stopper 30 is flexible, and there are a first stopper 30a and a second stopper 30b provided in this embodiment. The first stopper 30a is formed in a ring shape and includes multiple first spaced projections 31a, the second stopper 30b is formed in a ring shape and includes multiple second spaced projections 31b, wherein the first stopper 30a and the second stopper 30b are defined between the shock absorption sleeve 20 and the joining portion 10b of the power tool 10, the multiple first spaced projections 31a of the first stopper 30a and the multiple second spaced projections 31b of the second stopper 30b are biased against an inner wall of the shock absorption sleeve 20, and the first stopper 30a and the second stopper 30b are located at the accommodation space A1 so as to absorb vibration.

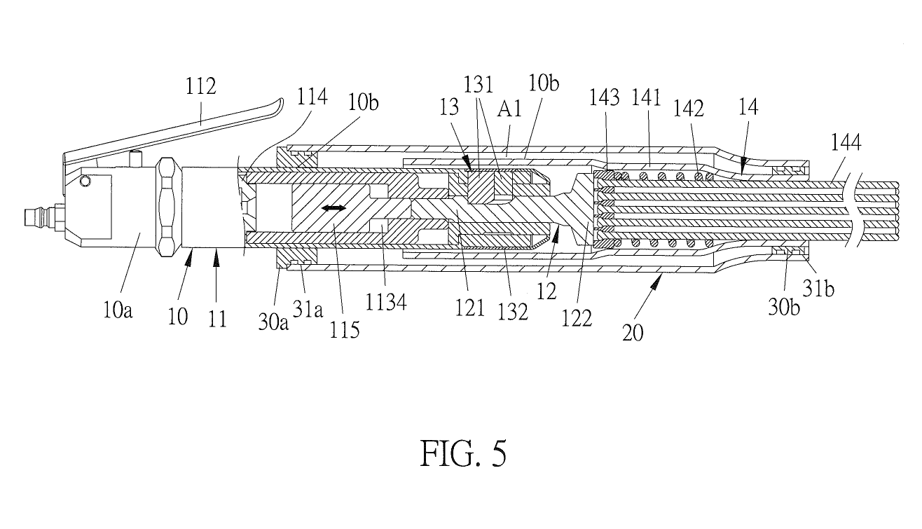

Referring to FIG. 5, in operation, a user holds the grip portion 10a with one hand and grips the shock absorption sleeve 20 with the other hand. After turning on the switch 112, high pressure gas pushes the impact part 115 to move toward the transmission part 12 from the drive block 111 via air valve 114 so that the transmission part 12 is hit by the impact part 115. Thereafter, the high pressure gas is controlled by the air valve 114 to push the impact part 115 to strike the air valve 114, hence the impact part 115 is pushed reciprocately so as to strike the transmission part 12, and the push disc 122 of the transmission part 12 pushes the holding seat 143 of the tool head 14 so that the plurality of rust removal needles 144 are driven by the holding seat 143 to remove rusts.

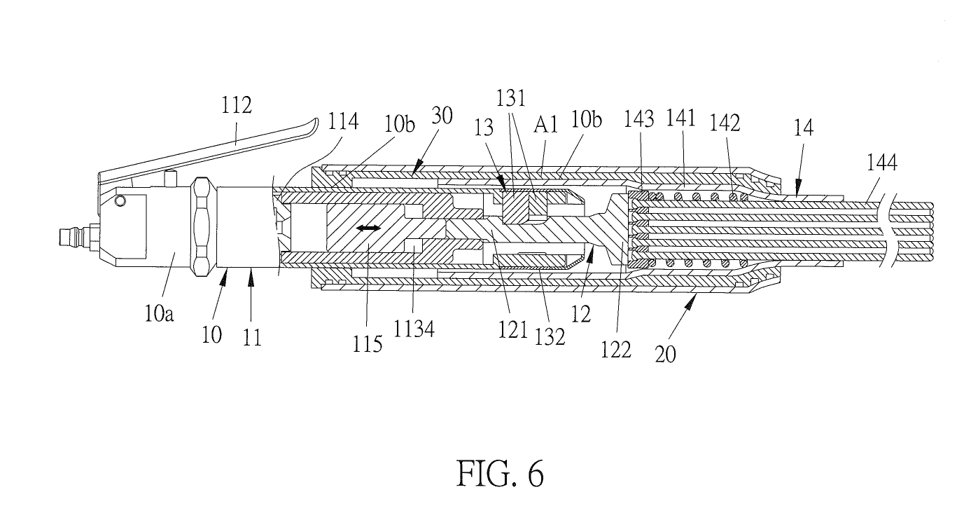

Referring to FIG. 6, the at least one stopper 30 is formed in an elongated sleeve shape and is defined between the shock absorption sleeve 20 and the joining portion 10b of the power tool 10, wherein the at least one stopper 30 is also located at the accommodation space A1 so as to absorb vibration.

Thereby, the shock absorbing protection structure of the present invention has advantages as follows:

The shock absorption sleeve 20 is fitted on the outer wall of the joining portion 10b of the power tool 10, and the at least one stopper 30 is defined between the shock absorption sleeve 20 and the joining portion 10b, such that the shock absorption sleeve 20 and the at least one stopper 30 absorb vibration as the handheld power tool operates, thus reducing reaction force to user's hands, operating the handheld power tool easily, and protecting the user's hand.

While various embodiments in accordance with the present invention have been shown and described, it is clear to those skilled in the art that further embodiments may be made without departing from the scope of the present invention.

What is claimed is:

1. A shock absorbing protection structure for a handheld tool comprising:
a power tool including a drive block for providing vibration power, and the driving block having a switch disposed on the drive block so as to turn on/off the drive block, the driving block also having a coupling tube connecting with the drive block, the coupling tube having a tool head fixed on one end of the coupling tube away from the drive block, and the power tool including a joining portion formed on an outer wall of the power tool;
a shock absorption sleeve fitted on an outer wall of the joining portion of the power tool, and between the shock absorption sleeve and the joining portion being defined an accommodation space; and
at least one stopper being flexible and defined between the shock absorption sleeve and the joining portion of the power tool, the at least one stopper being located at the accommodation space so as to absorb vibration.

2. The shock absorbing protection structure for the handheld tool as claimed in claim 1, wherein the at least one stopper is a first stopper and a second stopper, and the first stopper is formed in a ring shape, the second stopper is formed in a ring shape.

3. The shock absorbing protection structure for the handheld tool as claimed in claim 2, wherein the first stopper includes multiple first spaced projections, and the multiple first spaced projections of the first stopper are biased against an inner wall of the shock absorption sleeve.

4. The shock absorbing protection structure for the handheld tool as claimed in claim 2, wherein the second stopper includes multiple second spaced projections, and the multiple second spaced projections of the second stopper are biased against an inner wall of the shock absorption sleeve.

5. The shock absorbing protection structure for the handheld tool as claimed in claim 1, wherein the at least one stopper is formed in an elongated sleeve shape and is flexible.

6. The shock absorbing protection structure for the handheld tool as claimed in claim 1, wherein the power tool includes a body in which the drive block is housed, the coupling tube has an orifice defined on a central position of one end thereof away from the drive block, and the coupling tube also has a groove formed on an outer wall thereof, the groove has two notches communicating with the orifice, the coupling tube further has a chamber communicating with the orifice, wherein the chamber houses an air valve adjacent to the drive block, and the chamber also accommodates an impact part moving between the air valve and the orifice.

7. The shock absorbing protection structure for the handheld tool as claimed in claim 1, wherein the joining portion is the coupling tube.

8. The shock absorbing protection structure for the handheld tool as claimed in claim 6, wherein the power tool includes a transmission part, a connection unit, and a tool head; the transmission part has a column and a push disc, the connection unit has two limitation protrusions and a defining ring, wherein the column of the transmission part inserts into the orifice of the coupling tube of the body, the two limitation protrusions of the connection unit are housed in the two notches of the coupling tube, the defining ring of the connection unit retains in the groove of the coupling tube so that the transmission part is fixed in the one end of the coupling tube away from the drive block; the tool head includes a fitting sheath fitted on the outer wall of the coupling tube, the fitting sheath houses a resilient element and a holding seat, the holding seat accommodates a plurality of rust removal needles extending out of the fitting sheath, and the holding seat abuts against the push disc of the transmission part.

9. The shock absorbing protection structure for the handheld tool as claimed in claim 8, wherein the joining portion is the coupling tube and the fitting sheath.
